(19) United States
(12) Patent Application Publication
(10) Pub. No.: US 2008/0068305 A1
(43) Pub. Date: Mar. 20, 2008

(54) Burn-in reduction apparatus, self-luminous display apparatus, image processing apparatus, electronic device, burn-in reduction method, and computer program

(75) Inventor: Mitsuru Tada, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/892,719

(22) Filed: Aug. 27, 2007

(30) Foreign Application Priority Data
Sep. 15, 2006 (JP) 2006-250353

(51) Int. Cl. G09G 3/30

(52) U.S. Cl. 345/77

(57) ABSTRACT

Disclosed herein is A burn-in reduction apparatus, including: an illumination sensor configured to detect brightness of outside light incident on an area near a display screen; and a contrast control section configured to control a drive condition of a display device in accordance with the detected brightness to reduce a contrast ratio of display brightness steplessly or in a stepwise manner.

### CROSS REFERENCES TO RELATED APPLICATIONS

The present invention contains subject matter related to Japanese Patent Application JP 2006-250353, filed in the Japan Patent Office on Sep. 15, 2006, the entire contents of which being incorporated herein by reference.

### BACKGROUND OF THE INVENTION

1. Field of the Invention

The present invention relates to a technology of reducing a progress of a burn-in phenomenon in a self-luminous display apparatus. Aspects of the present invention include burn-in reduction apparatus, a self-luminous display apparatus, an image processing apparatus, an electronic device, a burn-in reduction method, and a computer program.

2. Description of the Related Art

A self-luminous display element has a property of decreasing in luminosity with increasing quantities of emitted light and time. This reduction in luminosity is because of degradation in luminous quality. If the degradation in luminous quality progresses, the reduction in luminosity also progresses gradually even under a steady drive condition, resulting in inability to maintain initial luminosity.

In general, the reduction in luminosity does not progress evenly, but variations occur in the degradation in luminous quality over a screen. This is because of unevenness of displayed content over the screen. A situation of the variations in the degradation in luminosity being visible is called a “burn-in phenomenon”.

In the past, the most preferable way to reduce the burn-in phenomenon has been thought to be to prolong a life span of a light-emitting device material.

However, a prolonged life span of the light-emitting device material may not theoretically eliminate the occurrence of the burn-in phenomenon, and only video signals that tend to cause burn-in may be inputted continuously.

As such, there is a proposed technique for delaying the occurrence of burn-in and making burn-in that has occurred less apparent (see, for example, Japanese Patent Laid-open No. 2003-228329).

### SUMMARY OF THE INVENTION

Japanese Patent Laid-open No. 2003-228329 discloses a method for illuminating, during a period when a display screen is unused, pixels so that each pixel will evenly decrease in quality. However, Japanese Patent Laid-open No. 2003-228329 does not describe any measure that can be employed when the display screen is used. Moreover, it is necessary to continuously monitor how much each pixel has decreased in quality, and with a large screen size, the amount of computation and a system scale will become great.

According to an embodiment of the present invention, it is desirable to provide a burn-in reduction apparatus that includes an illumination sensor and a contrast control section.

Here, the illumination sensor according to an embodiment of the present invention is a device for detecting brightness of outside light incident on an area near a display screen.

Further, according to an embodiment of the present invention, the contrast control section is a device for controlling a drive condition of a display device in accordance with the detected brightness, or performing gradation conversion of video signals, to reduce a contrast ratio of display brightness steplessly or in a stepwise manner.

A contrast ratio observed on the display screen is affected by the brightness of the outside light incident on the display screen. In the case where the incident outside light is bright, for example, the contrast ratio perceived by a person is considerably reduced even with a displayed image being the same.

According to an embodiment of the present invention, the contrast ratio of the display brightness is variably controlled steplessly or selectively in accordance with the brightness of the outside light to control the expansion of variations in the rate of degradation between self-luminous devices arranged within the display screen.

The burn-in phenomenon is perceived when differences in the degree of degradation between neighboring pixels have grown too greatly. Therefore, it is possible to reduce the occurrence of the burn-in phenomenon by reducing the rate of the expansion of the differences in the degree of degradation. Moreover, because the degree of the reduction in the contrast ratio is set in accordance with the brightness of the outside light incident on the display screen, a change or degradation in picture quality can be minimized.

Further, according to an embodiment of the present invention, it is not necessary to monitor how much each pixel has decreased in quality or control the quantity of emitted light on a pixel by pixel basis, eliminating the need for a large processing load or a large system scale. This offers an advantage over related-art techniques even when the screen size is large.

The above and other features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a diagram illustrating an exemplary functional structure of a burn-in reduction apparatus;

FIG. 2 is a diagram illustrating an exemplary arrangement of an illumination sensor;

FIG. 3 is a diagram illustrating an exemplary functional structure of a display device;

FIGS. 4A and 4B are diagrams illustrating a duty pulse signal;

FIG. 5 is a diagram illustrating a connection relationship between a pixel circuit and surrounding circuitry;

FIGS. 6A and 6B are diagrams illustrating a change in a contrast ratio in accordance with brightness of outside light;

FIG. 7 is a diagram illustrating exemplary calculation of a variation in the case where a black level is changed;

FIG. 8 is a diagram illustrating another exemplary calculation of a variation in the case where the black level is changed;

FIG. 9 is a diagram illustrating input-output characteristics of a data line driver used in the case where influence of the outside light is negligible;

FIG. 10 is a diagram illustrating display brightness characteristics relative to an input signal;

FIG. 11 is a diagram illustrating input-output characteristics of the data line driver used in the case where the black level is controlled;

FIG. 12 is a diagram illustrating how the black level is caused to vary continuously in accordance with illumination of the outside light;

FIG. 13 is a diagram illustrating display brightness characteristics relative to the input signal;

FIG. 14 is a diagram illustrating exemplary calculation of a variation in the case where a white level is changed;

FIG. 15 is a diagram illustrating another exemplary calculation of a variation in the case where the white level is changed;

FIG. 16 is a diagram illustrating input-output characteristics of the data line driver used in the case where the white level is controlled;

FIG. 17 is a diagram illustrating display brightness characteristics relative to the input signal;

FIG. 18 is a diagram illustrating exemplary calculation of a variation in the case where the black level and the white level are changed;

FIG. 19 is a diagram illustrating another exemplary calculation of a variation in the case where the black level and the white level are changed;

FIG. 20 is a diagram illustrating input-output characteristics of the data line driver used in the case where the black level and the white level are controlled;

FIG. 21 is a diagram illustrating display brightness characteristics relative to the input signal;

FIG. 22 is a diagram illustrating an exemplary functional structure of a burn-in reduction apparatus;

FIG. 23 is a diagram illustrating conversion characteristics used in the case where the black level is changed;

FIG. 24 is a diagram illustrating display brightness characteristics relative to the input signal;

FIG. 25 is a diagram illustrating an exemplary implementation of the burn-in reduction apparatus on a self-luminous display apparatus;

FIG. 26 is a diagram illustrating an exemplary implementation of the burn-in reduction apparatus on an image processing apparatus;

FIGS. 27 to 31 are diagrams each illustrating an exemplary implementation of the burn-in reduction apparatus on an electronic device;

FIGS. 32A and 32B are diagrams illustrating exemplary variable control of the duty pulse signal;

FIG. 33 is a diagram illustrating reduction in the contrast ratio owing to a change in the display brightness characteristics relative to the input signal; and

FIGS. 34A and 34B are diagrams illustrating another exemplary structure of the duty pulse signal.

### DETAILED DESCRIPTION OF THE PREFERRED EMBODIMENTS

Hereinafter, a specific example of a technique for reducing a contrast ratio of display-brightness in accordance with brightness of outside light to reduce the progress of burn-in without affecting visibility will be described.

Note that techniques in the related art are applied where no specific illustration or description is provided in this specification.

Also note that exemplary embodiments described below are simply exemplary embodiments of the present invention, and the present invention is not limited to these exemplary embodiments.

### (A) Exemplary First Embodiment

### (A-1) Functional Structure of Burn-In Reduction Apparatus

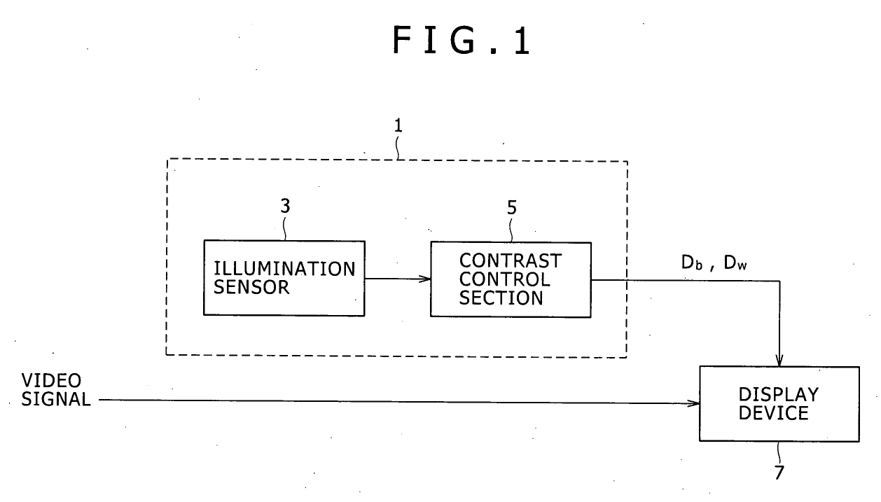

FIG. 1 shows an exemplary functional structure of a burn-in reduction apparatus 1. The burn-in reduction apparatus 1 includes an illumination sensor 3 and a contrast control section 5.

The illumination sensor 3 is a sensor element for detecting illumination at an area near a display device. The illumination sensor 3 is formed by a phototransistor, a photodiode, or an amplifier-equipped photodiode, for example. The illumination sensor 3 is arranged near a display surface of the display device to detect the brightness of outside light incident on the display surface.

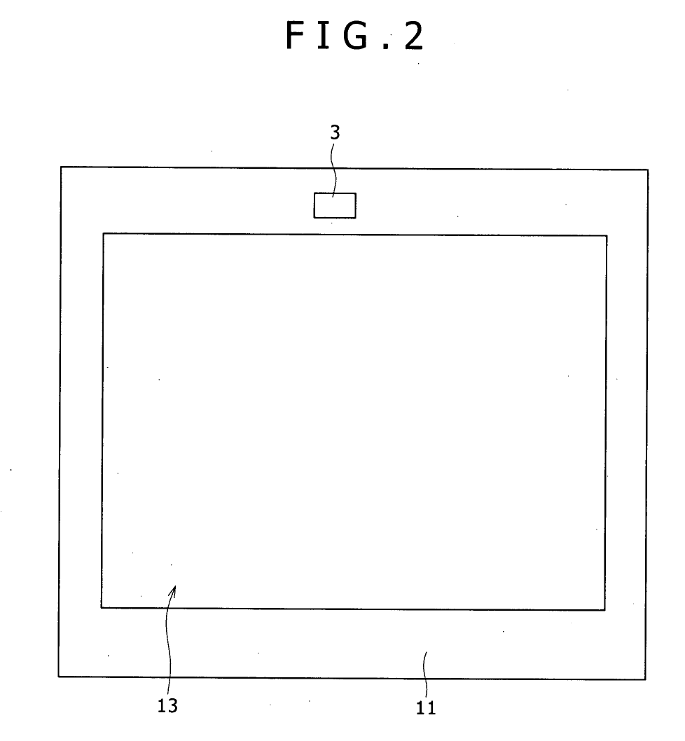

FIG. 2 shows an exemplary arrangement. FIG. 2 shows a display apparatus 11 as viewed from in front. In the case of FIG. 2, the illumination sensor 3 is arranged at an upper periphery of a display screen 13. The illumination sensor 3 is arranged near the middle of the screen because the screen is most frequently viewed at the middle.

Since the illumination sensor 3 is to measure or estimate the brightness of the outside light incident on the display screen 13, the illumination sensor 3 may be arranged on a side of the display apparatus 11 instead of on the same surface as the display screen 13. The position at which the illumination sensor 3 is arranged is basically determined based on the screen size of the display apparatus or the shape of an electronic device on which the illumination sensor 3 is mounted, or how they are used.

The contrast control section 5 is a processing device for controlling a drive condition of a display device 7 in accordance with the brightness of the outside light incident on an area near the display screen to reduce the contrast ratio of the display brightness steplessly.

In the present embodiment, the brightness of the outside light incident on the display screen is inputted to the contrast control section 5 as a detected value of the illumination sensor 3.

Based on the detected value of the illumination sensor 3, the contrast control section 5 calculates the amount of increase in screen brightness caused by influence of the outside light. The amount of increase in screen brightness is calculated based on an operation equation or a correspondence table previously prepared based on an experimental result.

As a result of the calculation of the amount of increase in screen brightness, a contrast ratio observed under the outside light is determined.

When the contrast ratio that reflects the influence of the outside light has been determined as described above, the contrast control section 5 determines a drive condition for further reducing the contrast ratio, and controls the display device 7 based on the determined drive condition. Note that it is desirable that the amount of further reduction in the contrast ratio be optimized in accordance with the performance of the display device 7, illumination of a surrounding area, or the like.

In the present embodiment, the contrast control section 5 performs, based on prior setting, a process of calculating the amount of increase in black level of the display brightness, a process of calculating the amount of reduction in white level of the display brightness, or both of the processes.

Based on the amount of increase or the amount of reduction calculated, the contrast control section 5 performs a process of variably controlling reference voltage values that define the black and white levels of a data line driver that forms a part of the display device 7.

In the case of increasing the black level, for example, the contrast control section 5 raises the reference voltage value that defines the black level of the data line driver by a voltage value corresponding to the amount of increase calculated. Meanwhile, in the case of reducing the white level, for example, the contrast control section 5 reduces the reference voltage value that defines the white level of the data line driver by a voltage value corresponding to the amount of reduction calculated.

### (A-2) Structure of Display Device

In the present embodiment, the display device is assumed to be an organic EL display, which is an example of a self-luminous display device.

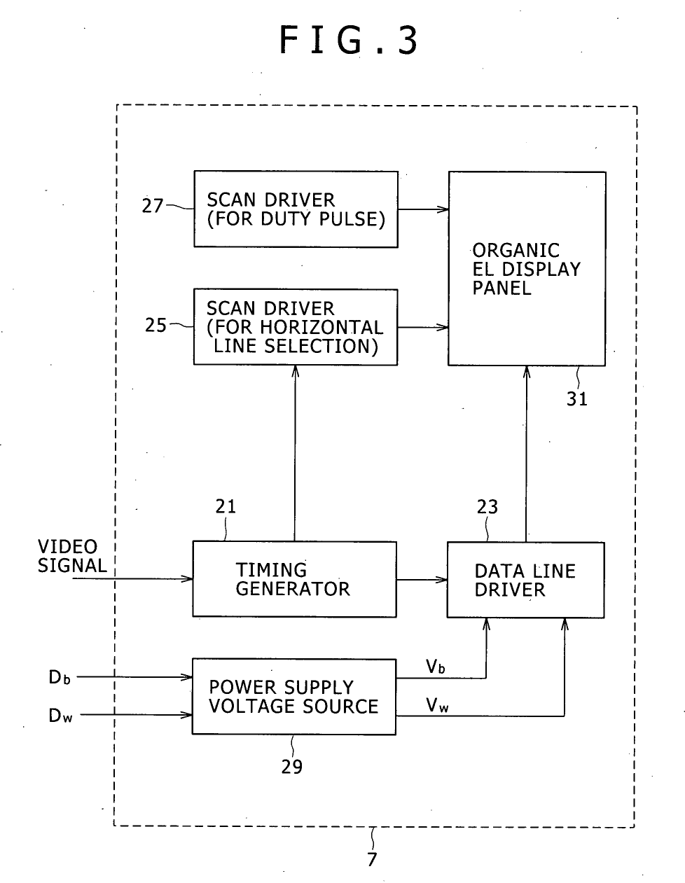

FIG. 3 shows an exemplary functional structure of the display device 7. The display device 7 includes a timing generator 21, a data line driver 23, a scan driver 25, a scan driver 27, a power supply voltage source 29, and an organic EL display panel 31.

The timing generator 21 is a processing device for generating various timing signals necessary for screen display based on a timing signal contained in a video signal. The timing generator 21 generates a write pulse and so on, for example.

The data line driver 23 is a circuit device for driving data lines of the organic EL display panel 31. The data line driver 23 is formed by a digital/analog converter that performs an operation of converting a gradation value that specifies the luminosity of each pixel into an analog voltage value and supplying it to the data lines. A reference voltage V_{b} that defines the black level and a reference voltage V_{w} that defines the white level of the digital/analog converter are supplied from the power supply voltage source 29.

The scan driver 25 is a circuit device for selecting, in a line-sequential manner, gate lines provided for selecting a horizontal line to which the gradation value is written. A signal for selection thereof is supplied to the organic EL display panel 31 as the write pulse. The scan driver 25 in this embodiment outputs the write pulse on a horizontal line by horizontal line basis.

The scan driver 27 is a circuit device for driving gate lines provided for supplying a duty pulse signal. The duty pulse signal refers to a signal that defines the length of an illumination time within one frame period.

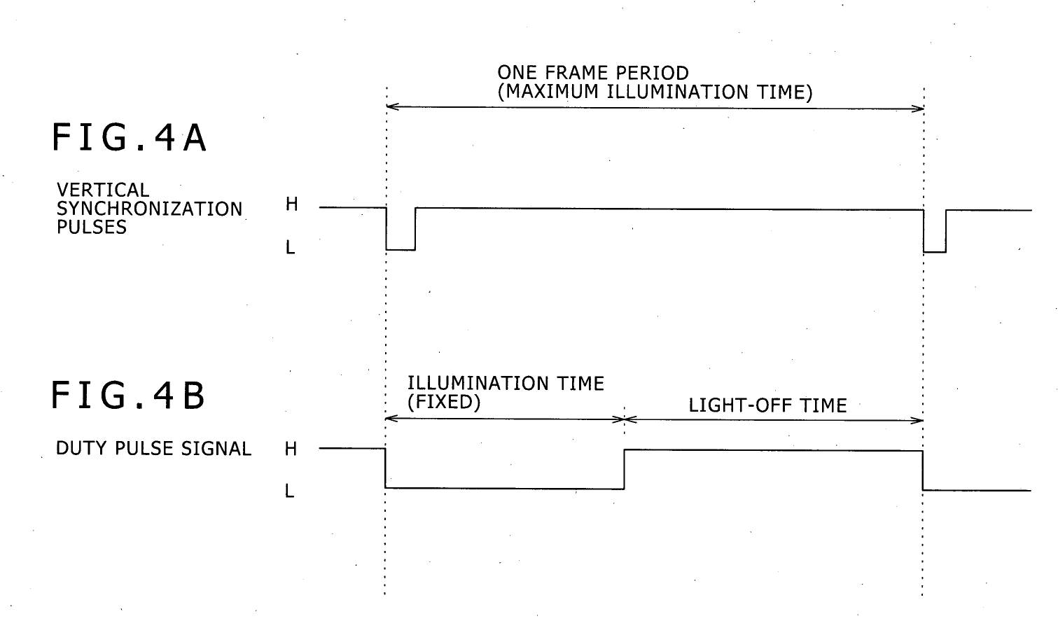

FIGS. 4A and 4B show an example of the duty pulse signal. FIG. 4A shows vertical synchronization pulses that define a maximum period of the length of a maximum illumination time. FIG. 4B shows an example of the duty pulse signal. In FIG. 4B, an L level period corresponds to the length of the illumination time within one frame period. In this embodiment, the illumination time is fixed.

The power supply voltage source 29 is a circuit device for generating the reference voltages V_{b} and V_{w} to be supplied to the data line driver 23, based on the reference voltage values D_{b} and D_{w} supplied from the contrast control section 5.

The organic EL display panel 31 is a display device in which organic EL elements are arranged in a matrix. The organic EL display panel 31 allows color display. Therefore, one pixel in terms of display is composed of subpixels that correspond to RGB color components.

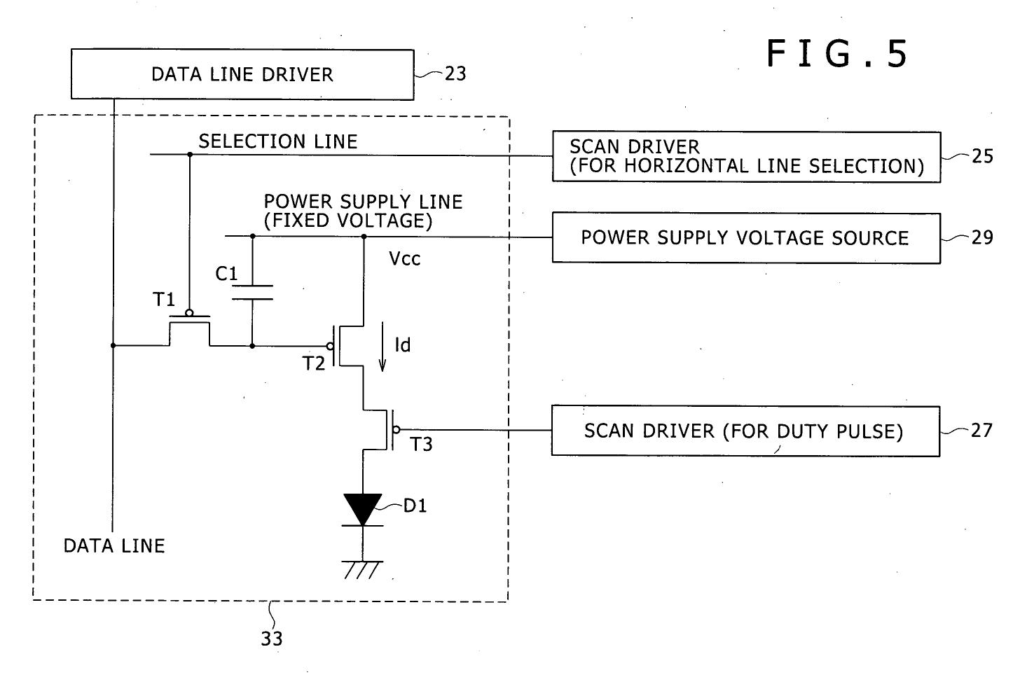

FIG. 5 shows a connection relationship between a pixel circuit 33 formed at an intersection of a data line and a selection line and neighboring circuitry.

The pixel circuit 33 includes a switch element T1, a capacitor C1, a current supply element T2, and an illumination period control element T3.

Here, the switch element T1 is a transistor for controlling taking in (writing) of the voltage value supplied via the data line. Timing of the taking in of the voltage value is provided on a horizontal line by horizontal line basis.

The capacitor C1 is a storage element for holding the taken-in voltage value for one frame period. Use of the capacitor C1 realizes an illumination mode similar to that of a frame-sequential scanning system even when data writing is performed in accordance with a line-sequential scanning system.

The current supply element T2 is a transistor for supplying a drive current corresponding to the voltage value held in the capacitor C1 to an organic EL element D1.

The illumination period control element T3 is a transistor for controlling the length of the illumination time of the organic EL element D1 within one frame.

The illumination period control element T3 is arranged in series with respect to a path along which the drive current is supplied. While the illumination period control element T3 is on, the organic EL element D1 is illuminated. Meanwhile, while the illumination period control element T3 is off, the organic EL element D1 is not illuminated. Note that, however, the length of the illumination time is fixed in this exemplary embodiment.

### (A-3) Burn-In Reduction Process

Hereinafter, exemplary operations for burn-in reduction, which use different methods for reducing the contrast ratio, will be described sequentially.

(a) Reduction in Contrast Ratio because of Incoming Outside Light

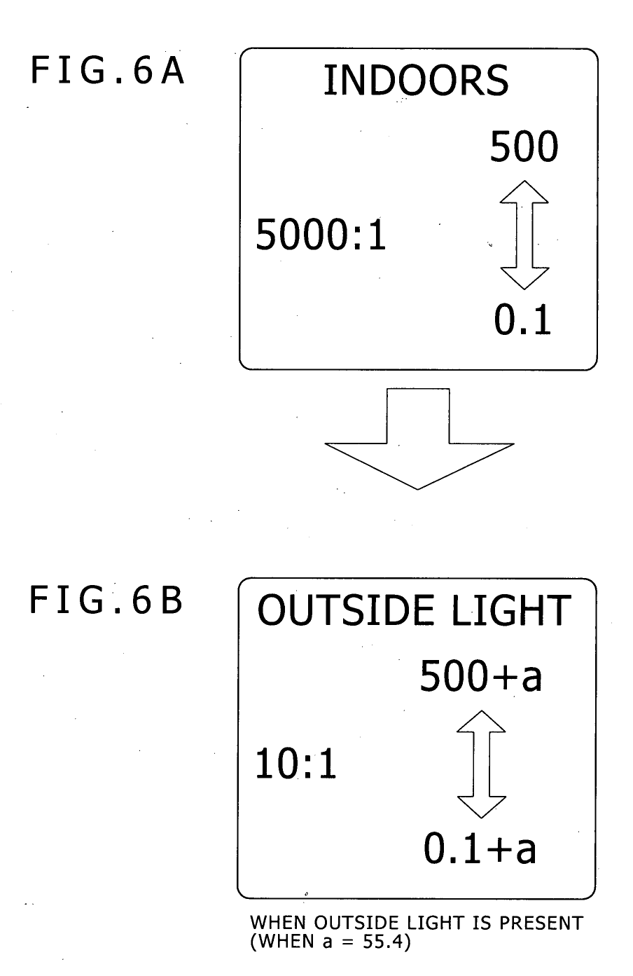

FIGS. 6A and 6B illustrate how the contrast ratio changes because of the brightness of the outside light.

FIG. 6A shows a contrast ratio when the outside light is almost negligible. In this example, the display brightness varies within a range between 0.1 [nit] and 500 [nit]. In this case, the contrast ratio is 5000:1.

FIG. 6B shows a contrast ratio when the outside light is bright. FIG. 6B shows an exemplary case where the illumination sensor 3 has detected outside light that corresponds to a display brightness of 55.4 [nit].

In this case, the black level of the display screen is changed to 55.5 (=0.1+55.4) [nit]. Meanwhile, the white level of the display screen is changed to 555.4 [nit]. In this case, the contrast ratio is 10:1.

In short, the brightness of the outside light has reduced the contrast ratio by a factor of 500. While this is an example where the outside light is extremely bright, impingement of the outside light on the display screen causes the black level as perceived with the eyes to be brighter than the display brightness specific to the display device. Needless to say, the white level is also caused to be brighter.

While the contrast ratio as perceived with the eyes has been reduced, the contrast ratio of actual display on the display device is maintained at 5000:1. Therefore, if a fixed pattern with large brightness variations is continuously displayed, expansion of differences in the degree of degradation, which is the cause of the burn-in, progresses.

As such, the present inventor positively utilizes the reduction in the contrast ratio caused by the influence of the outside light. Specifically, in view of the fact that visibility is reduced because of the outside light, the contrast ratio of the display brightness is controlled to be reduced in accordance with the brightness of the outside light. This controlled reduction of the contrast ratio reduces the progress of the burn-in phenomenon.

There are three methods for reducing the contrast ratio of the display brightness: a method of raising the black level, a method of reducing the white level, and a combination of the two methods.

Which of these methods is adopted depends on the prior setting as well as consideration of the brightness of the outside light. These three methods can be applied regardless of whether the outside light is bright or dark. These methods will now be described below sequentially.

(b) Process of Reducing Contrast Ratio by Variable Control of Black Level

Here, a case where the contrast control section 5 raises the black level of the data line driver 23 will be described. That is, a method of setting a new control target based on the contrast ratio determined in accordance with the brightness of the outside light will be described.

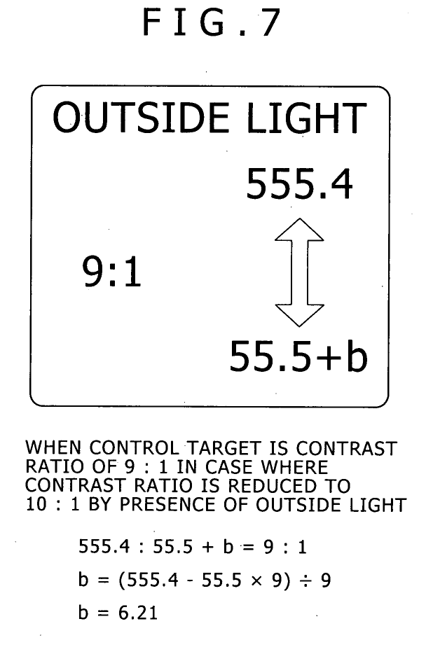

First, a case where the control target is a contrast ratio of 9:1 will be described with reference to FIG. 7. In FIG. 7, a variation in display brightness because of floating black is denoted as b.

In this case, taking the amount of increase in brightness because of floating black into account, the black level of the display screen is denoted by 55.5+b [nit].

Meanwhile, the white level of the display screen is 555.4 [nit], and therefore, the variation b for allowing the contrast ratio to be 9:1 is calculated by (555.4−55.5×9)÷9.

As a result of calculation, it is found that the amount of increase in the black level is 6.21 [nit] in terms of brightness. The contrast ratio control section 5 sets the reference voltage value D_{b} for the black level so as to satisfy this amount of increase, and supplies the set reference voltage value D_{b} to the data line driver 23.

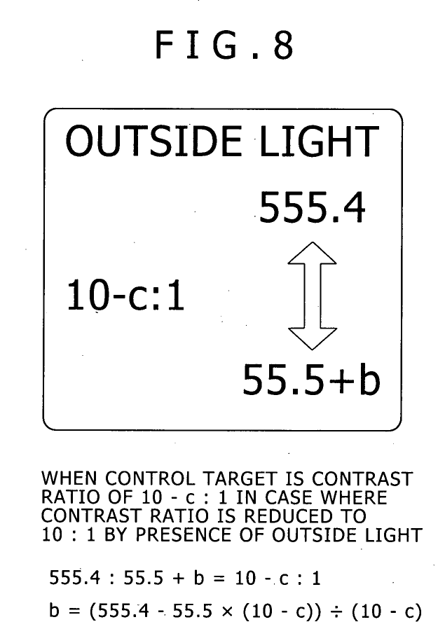

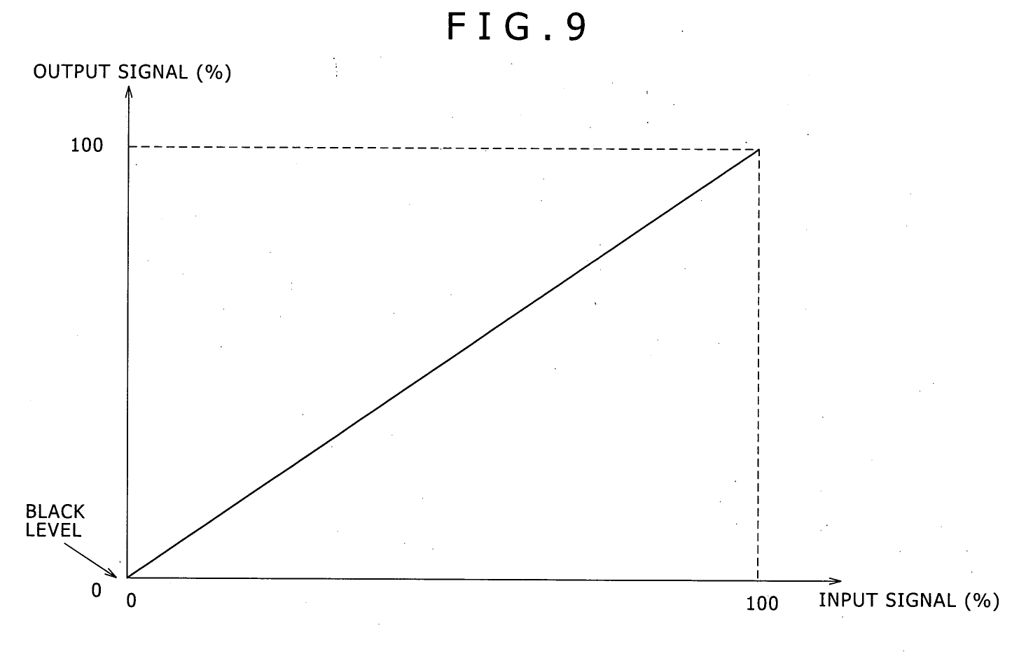

FIG. 8 shows a generalized example. FIG. 8 shows a case where the control target is a contrast ratio of 10−c:1. The case of FIG. 7 is a case where parameter c is set at 10% of a standard contrast ratio. Here, the variation in the display brightness because of the increased black level is also denoted as b.

In this case, taking the amount of increase in brightness because of floating black into account, the black level of the display screen is denoted by 55.5+b [nit]. Meanwhile, the white level of the display screen is 555.4 [nit]. Therefore, the variation b for allowing the contrast ratio to be 10−c:1 is calculated by (555.4−55.5×(10−c))÷(10−c).

Needless to say, the contrast control section 5 obtains a voltage value corresponding to the calculation to set the reference voltage value D_{b} for the black level.

Input-output characteristics and a change in the contrast ratio in this example are illustrated in FIGS. 9 to 13.

FIG. 9 shows input-output characteristics of the data line driver 23 used in the case where the influence of the outside light is negligible. The black and white levels in this case are 0% brightness and 100% brightness, respectively.

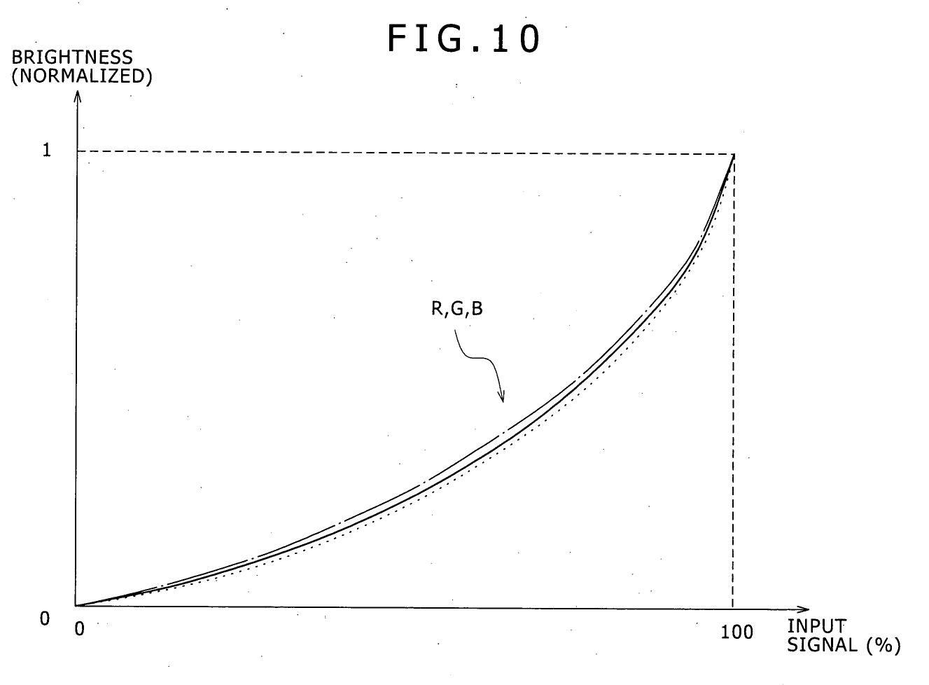

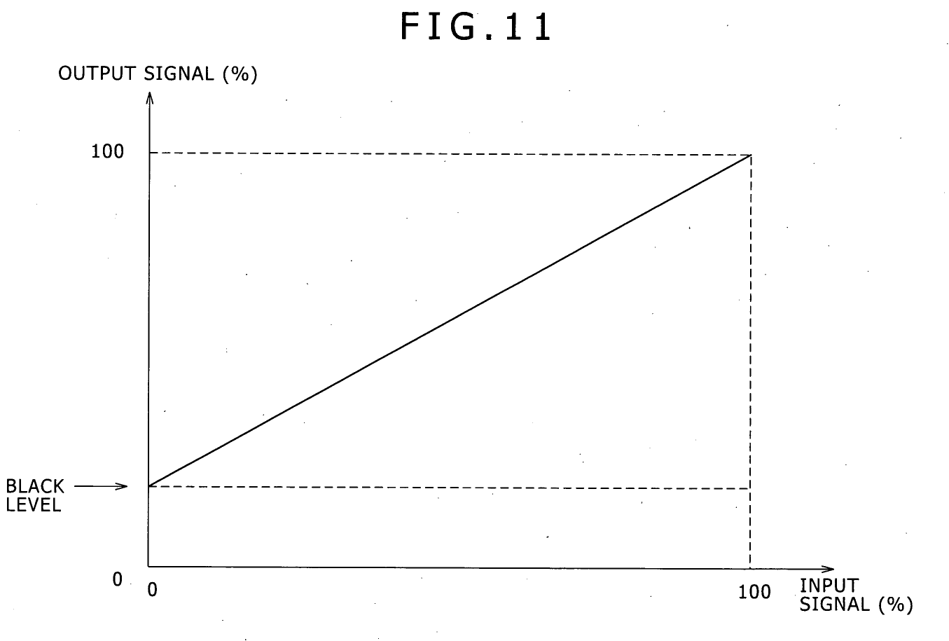

FIG. 10 shows display brightness characteristics relative to an input signal. Note that in FIG. 10, with a maximum brightness level as 1, screen brightness characteristics of the other gradation values are normalized. Also note that in FIG. 10, screen brightness characteristics in three colors, red (R), green (G), and blue (B), are normalized to those of one of the three colors that has the highest maximum brightness level.

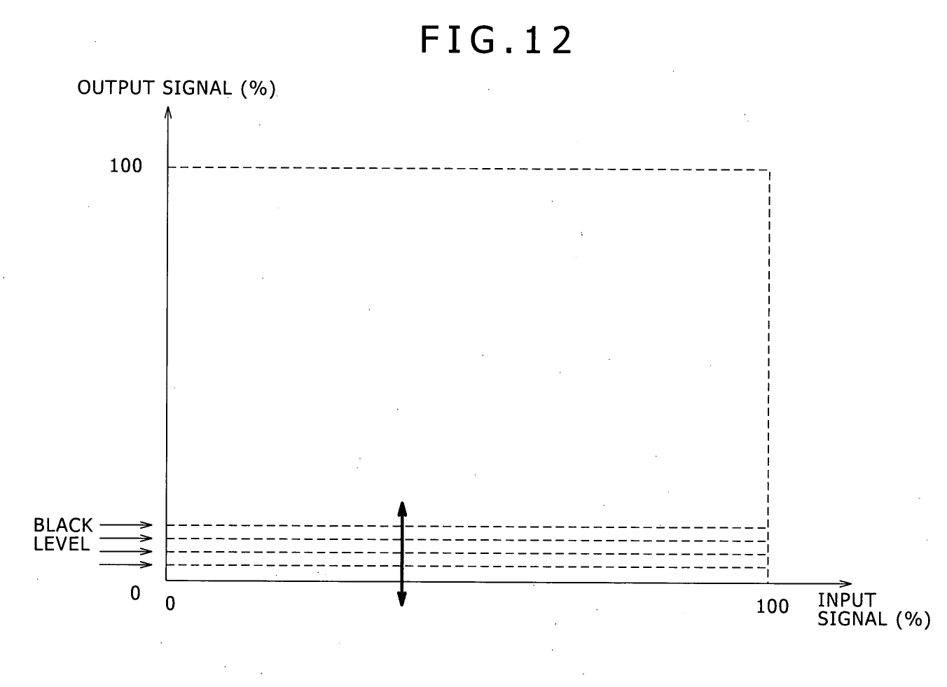

FIG. 11 shows input-output characteristics of the data line driver 23 used when the contrast ratio is controlled to be reduced. As shown in FIG. 11, a process of positively raising the black level, which is damaged in visibility by the influence of the outside light, is performed.

As shown in FIG. 12, the degree to which the black level is raised varies in accordance with the brightness of the outside light, or the like.

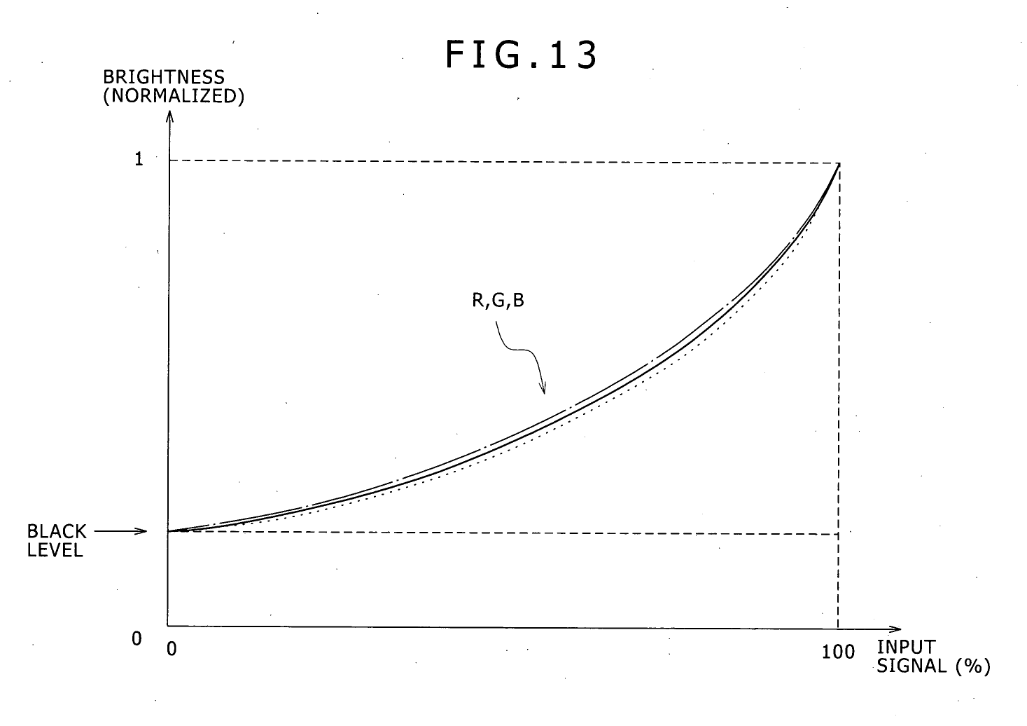

FIG. 13 shows display brightness characteristics relative to the input signal. From FIG. 13, it is apparent that the raise in the black level results in a reduced contrast ratio of the display brightness.

(c) Process of Reducing Contrast Ratio by Variable Control of White Level

Here, a case where the contrast control section 5 reduces the white level of the data line driver 23 will be described. In the case where the outside light is bright, for example, the display brightness is often increased to improve visibility of a high-brightness area.

However, an excessive increase in the display brightness often results in reduced visibility of the high-brightness area, necessitating a viewer to block incident outside light with a hand. Therefore, the method of reducing the white level is effective when the outside light is bright.

On the other hand, when the outside light is dark, the human eyes can easily detect picture quality, and therefore, it is preferable to reduce the white level to reduce the contrast ratio.

The manner of determining the control-target contrast ratio is the same as when raising the black level.

That is, the control target is newly set based on the contrast ratio determined in accordance with the brightness of the outside light.

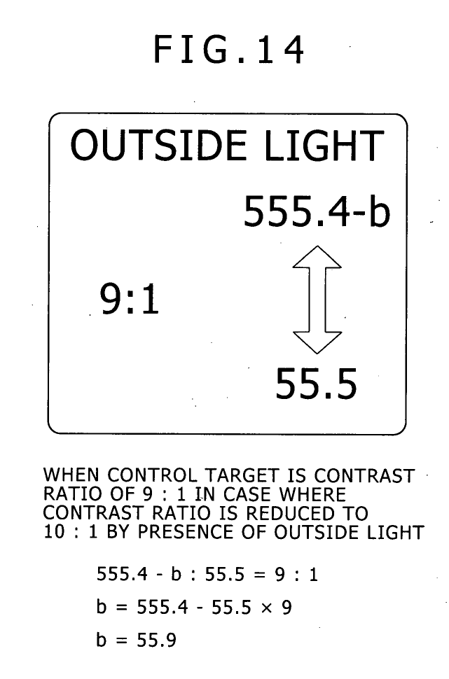

First, referring to FIG. 14, a case where the control target is a contrast ratio of 9:1 will now be described below. In FIG. 14, a variation in the display brightness because of the reduction in the white level is denoted as b.

In this case, the black level of the display screen is 55.5 [nit] because of floating black. Meanwhile, taking the floating black into account, the white level of the display screen is denoted by 555.4−b [nit]. Therefore, the variation b for allowing the contrast ratio to be 9:1 is calculated by 555.4−55.5×9.

As a result of calculation, it is found that the amount of reduction in the white level is 55.9 [nit] in terms of brightness. The contrast ratio control section 5 sets the reference voltage value D_{w} for the white level so as to satisfy this amount of reduction, and supplies the set reference voltage value D_{w} to the data line driver 23.

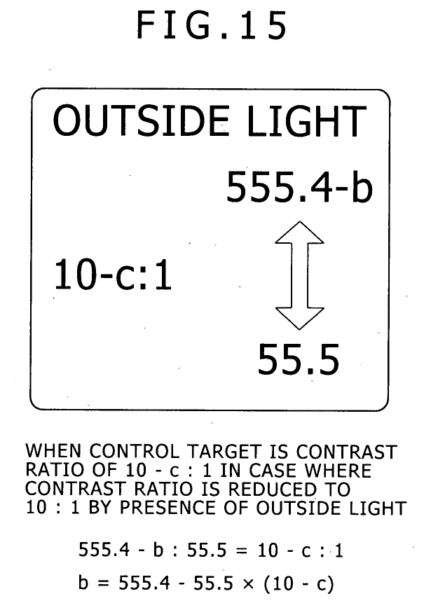

FIG. 15 shows a generalized example. FIG. 15 shows a case where the control target is a contrast ratio of 10−c:1. The case of FIG. 14 is a case where parameter c is set at 10% of the standard contrast ratio. Here, the variation in the display brightness because of the reduction in the white level is also denoted as b.

In this case, taking the amount of increase in brightness because of floating black into account, the black level of the display screen is 55.5 [nit]. Meanwhile, the white level of the display screen is denoted by 555.4−b [nit]. Therefore, the variation b for allowing the contrast ratio to be 10−c:1 is calculated by 555.4−55.5×(10−c).

Needless to say, the contrast control section 5 obtains a voltage value corresponding to the calculation to set the reference voltage value D_{w} for the white level.

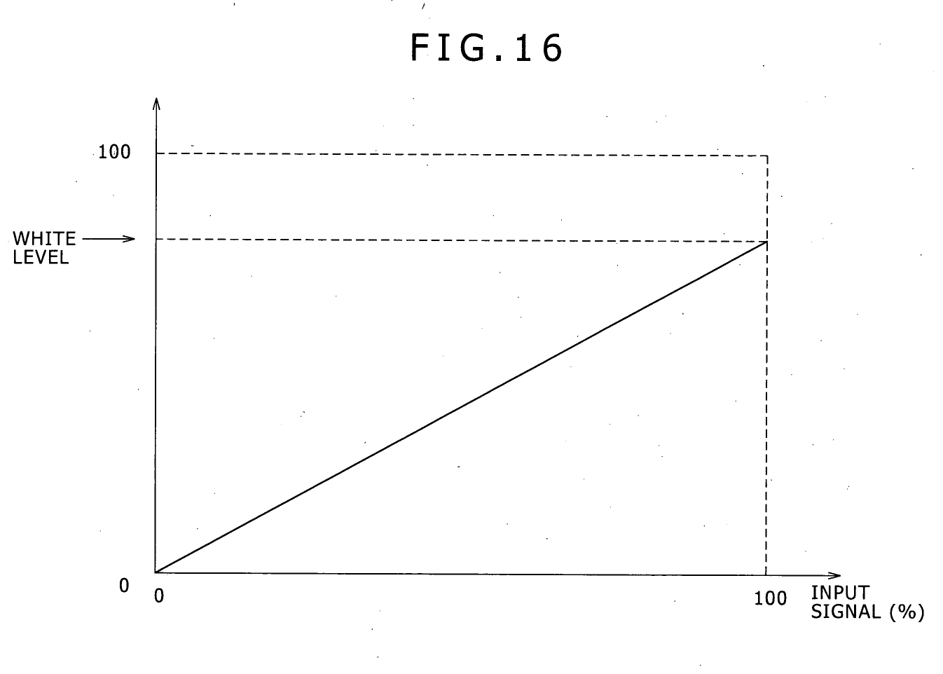

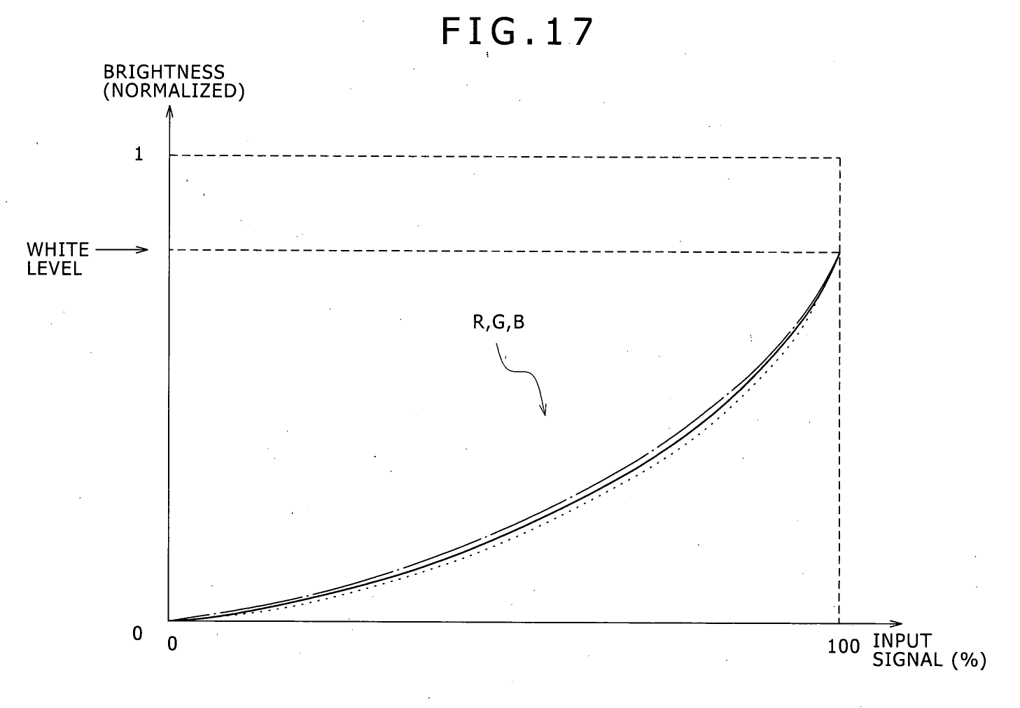

Input-output characteristics and a change in the contrast ratio in this example are illustrated in FIGS. 16 and 17.

FIG. 16 shows input-output characteristics of the data line driver 23 used when the contrast ratio is controlled to be reduced. As shown in FIG. 16, a process of positively reducing the white level is performed.

FIG. 17 shows display brightness characteristics in this case. As shown in FIG. 17, the reduction in the white level results in a reduced contrast ratio of the display brightness.

(d) Process of Reducing Contrast Ratio by Variable Control of Black and White Levels

Here, a case where the contrast control section 5 variably controls both the black level and the white level of the data line driver 23 will be described. In other words, a case where the black level is raised while the white level is reduced will be described.

The manner of determining the control-target contrast ratio is basically the same as when variably controlling the black level or the white level. That is, the control target is newly set based on the contrast ratio determined in accordance with the brightness of the outside light. In this control example, however, there are two variations, and when after one variation is determined, the other variation can be determined.

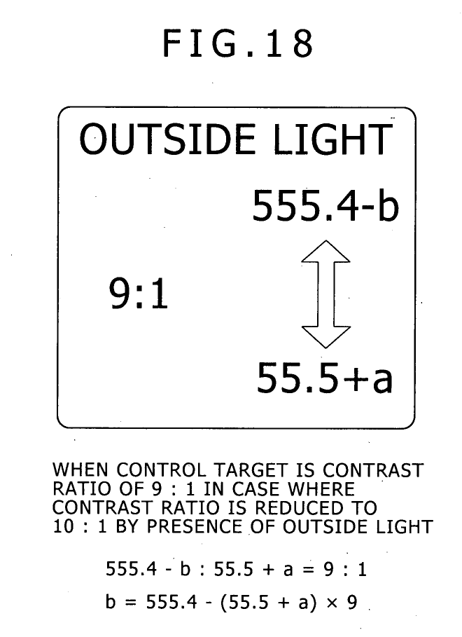

First, a case where the control target is a contrast ratio of 9:1 will be described with reference to FIG. 18. In FIG. 18, a variation in the display brightness because of increase in the black level is denoted as a, while a variation in the display brightness because of reduction in the white level is denoted as b.

In this case, the black level of the display screen is 55.5+a [nit] because of floating black. Meanwhile, taking the floating black into account, the white level of the display screen is 555.4−b [nit]. In this case, the variation b for allowing the contrast ratio to be 9:1 is calculated by 555.4−(55.5+a)×9 using the variation a, which has been previously set.

Conversely, in the case where the variation b is previously set, the variation a is calculated by (555.4−b−55.5×9)÷9.

When the variation in the black level and the variation in the white level have been determined as a result of calculation, the contrast ratio control section 5 sets the reference voltage value D_{b} for the black level and the reference voltage value D_{w} for the white level so as to satisfy these variations, and supplies the set reference voltage values D_{b} and D_{w} to the data line driver 23.

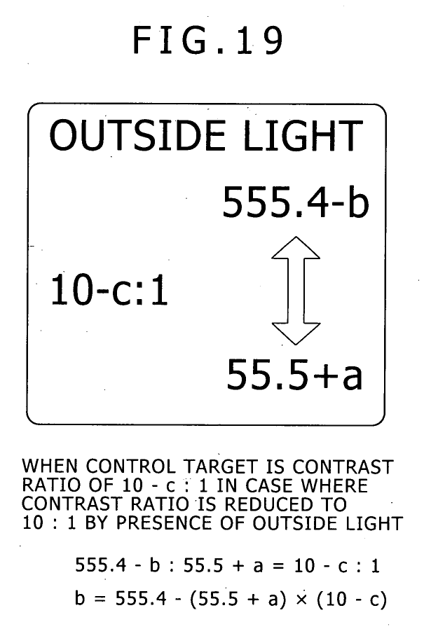

FIG. 19 shows a generalized example. FIG. 19 shows a case where the control target is a contrast ratio of 10−c:1. The case of FIG. 18 is a case where parameter c is set at 10% of the standard contrast ratio. Here also, the variation in the display brightness because of the increase in the black level is denoted as a, and the variation in the display brightness because of the reduction in the white level is denoted as b.

In this case, taking the amount of increase in brightness because of floating black into account, the black level of the display screen is denoted by 55.5+a [nit]. Meanwhile, the white level of the display screen is denoted by 555.4−b [nit]. In this case, the variation b for allowing the contrast ratio to be 10−c:1 is calculated by 555.4−(55.5+a)×(10−c) using the variation a, which has been previously set.

In the case where, conversely, the variation b is previously set, the variation a is calculated by (555.4−b−55.5×(10−c))÷(10−c).

When the variation in the black level and the variation in the white level have been determined as a result of calculation, the contrast ratio control section 5 sets the reference voltage value D_{b} for the black level and the reference voltage value D_{w} for the white level so as to satisfy these variations, and supplies the set reference voltage values D_{b} and D_{w} to the data line driver 23.

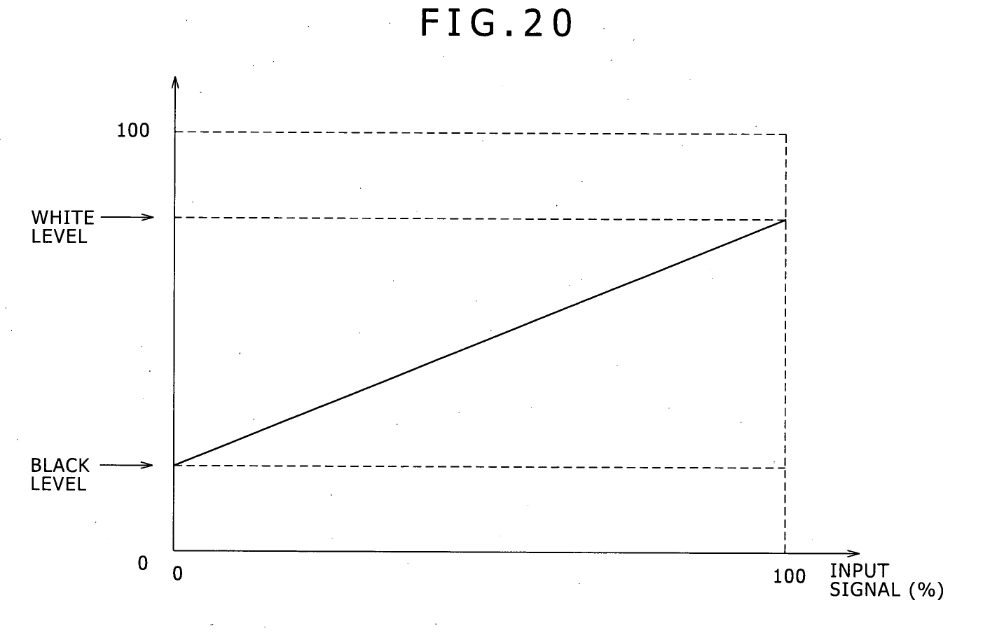

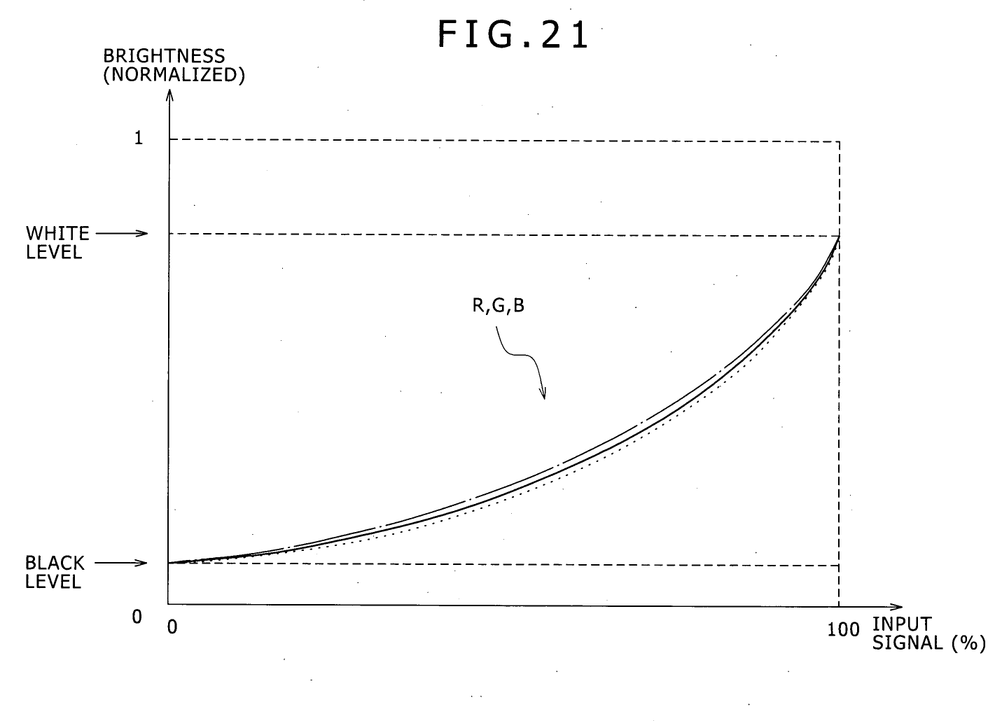

Input-output characteristics and a change in the contrast ratio in this example are illustrated in FIGS. 20 and 21.

FIG. 20 shows input-output characteristics of the data line driver 23 used when the contrast ratio is controlled to be reduced. FIG. 21 shows display brightness characteristics in this case. As shown in FIG. 21, the raised black level and the reduced white level result in a reduced contrast ratio of the display brightness.

### (A-4) Effects

As described above, by detecting the brightness of the outside light using the illumination sensor 3, and reducing the contrast ratio of the display brightness in accordance with the detected brightness, it is possible to reduce the differences in the degree of degradation between the organic EL elements accumulated by display during a control period compared to those caused by original display.

This results in delay in perceiving the burn-in phenomenon. That is, it is possible to reduce the occurrence of the burn-in phenomenon.

Indeed, the reduction in the contrast ratio leads to reduction in picture quality, but when the outside light is bright, the contrast ratio as perceived with the eyes is decreased originally. Therefore, the reduction in the contrast ratio of the display brightness does not cause uncomfortableness concerning the picture quality. Meanwhile, when the outside light is dark, the reduction in the contrast ratio does not prevent the picture quality from being maintained at a sufficient level, and therefore, no unconfortableness occurs concerning the picture quality.

Moreover, the burn-in reduction apparatus 1 can be realized in a small-scale circuit. Therefore, it is possible to arrange the burn-in reduction apparatus 1 at a part of an integrated circuit (IC) or the like mounted on the display device 7.

In the case of the display device 7 as shown in FIG. 3, for example, it is possible to arrange the burn-in reduction apparatus 1 at a part of the timing generator 21. In the case where the burn-in reduction apparatus 1 is thus arranged at a part of an already existing processing circuit, there is no need to modify a layout or arrangement space. This is advantageous in terms of production costs as well.

In particular, even in the case where the screen size is large, a large amount of computation or a large system scale is not necessary. This is advantageous in terms of the production costs.

Moreover, the reduction in the contrast ratio results in reduction in power consumption. This is especially beneficial when the display device is mounted on a battery device, as an extended drive time is achieved.

### (B) Exemplary Second Embodiment

Here, a burn-in reduction apparatus that performs a process of reducing the contrast ratio via gradation conversion of video signals will be described.

### (B-1) Functional Structure of Burn-In Reduction Apparatus

FIG. 22 shows an exemplary functional structure of this type of burn-in reduction apparatus 41. Note that in FIG. 22, parts that have corresponding parts in FIG. 1 are assigned the same reference numerals as in FIG. 1.

The burn-in reduction apparatus 41 includes the illumination sensor 3 and a contrast control section 43.

The contrast control section 43 performs a process of calculating a variation in the display brightness based on the brightness of the outside light detected by the illumination sensor 3, and a process of performing gradation conversion of the video signals based on conversion characteristics corresponding to the variation calculated.

In this embodiment also, the contrast ratio may be controlled by any of the three methods: the method of raising the black level, the method of reducing the white level, and the combination of the two methods.

The manner of calculating the variation in each of the three methods is the same as in exemplary first embodiment, and therefore, description thereof is omitted.

In this embodiment, the contrast control section 43 sets conversion characteristics corresponding to the variation calculated, and performs a process of converting a video signal (a gradation value) corresponding to each pixel into an output gradation value based on the set conversion characteristics.

The conversion process here is achieved, for example, by identifying an appropriate conversion table from among conversion tables previously prepared based on the control method and the variation, and reading the identified conversion table. However, it is not practical to prepare conversion tables for all variations. Actually, since the purpose of this control is to achieve reduction in burn-in, the precision in contrast control can be sacrificed to some extent.

Therefore, it may be so arranged that several conversion tables corresponding to several variations are prepared in advance, and a conversion table of one of the several variations that is closest to the variation calculated is selectively applied.

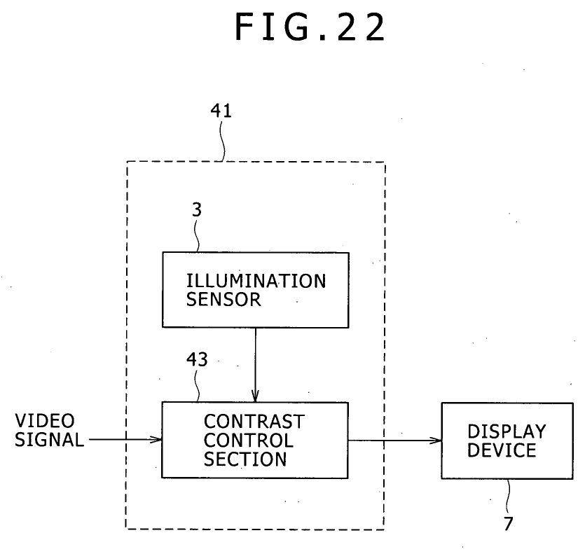

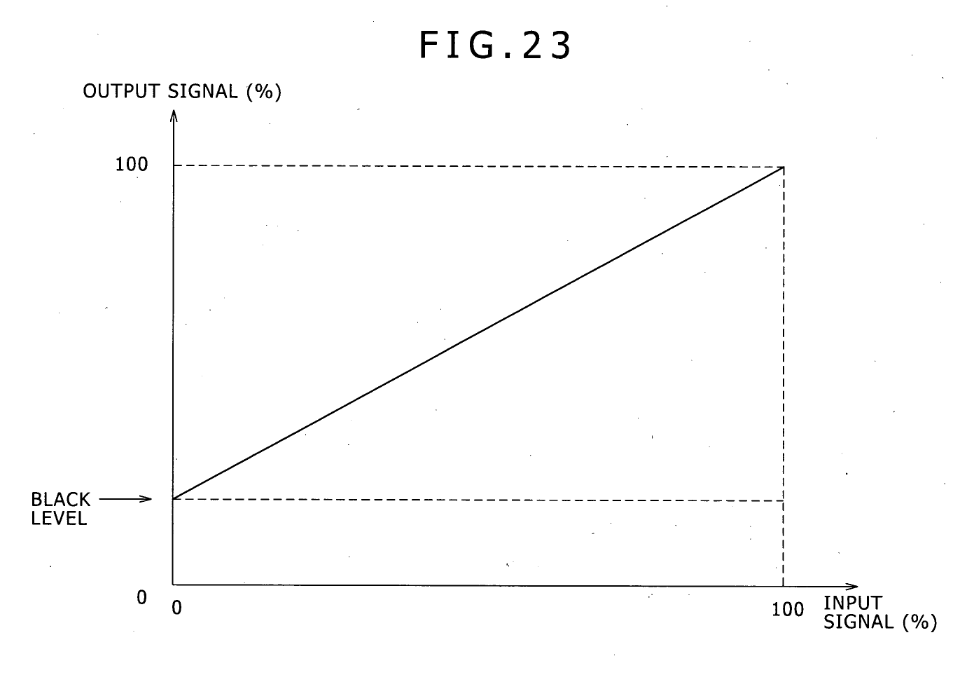

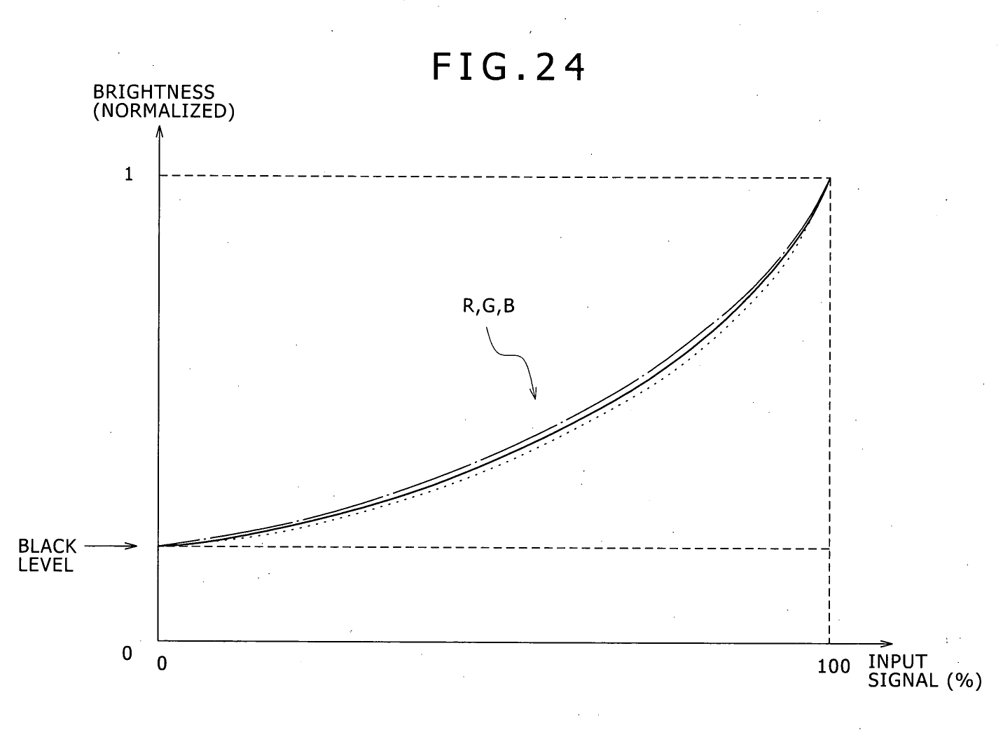

FIG. 23 shows an input-output relationship of a conversion table used in the case where the black level is controlled. Use of this conversion table achieves display brightness characteristics as shown in FIG. 24.

These characteristics are the same as those described above with reference to exemplary first embodiment.

Needless to say, the same characteristics as in exemplary first embodiment can also be applied when the white level is controlled and when the black and white levels are controlled simultaneously.

Besides, the gradation conversion by the contrast control section 43 can be achieved by a computation process as well. This is because conversion of the variation calculated into the gradation value is possible if the control method (the method of controlling the black level, the method of controlling the white level, or the method of controlling the both) and the variation are determined.

In the case where the black level is controlled, for example, a conversion formula that gives a straight line that passes through a gradation value corresponding to the variation in the black level and a gradation value corresponding to the 100% brightness white level is obtained. Since this is a linear transformation, a large amount of computation is not for the conversion process. Moreover, since storage of the conversion tables is not necessary, large storage capacity is not necessary on a processing system.

### (B-2) Effects

As described above, in the case where the gradation conversion of the video signals is performed, the same effects as in exemplary first embodiment are achieved. That is, the reduction in the rate of the progress of burn-in is achieved by reducing the contrast ratio of the display brightness in accordance with the brightness of the outside light.

### (C) Exemplary Implementations

Here, exemplary implementations, of the above-described burn-in reduction apparatus on electronic devices will be described.

(a) Implementation on Self-Luminous Display Apparatus

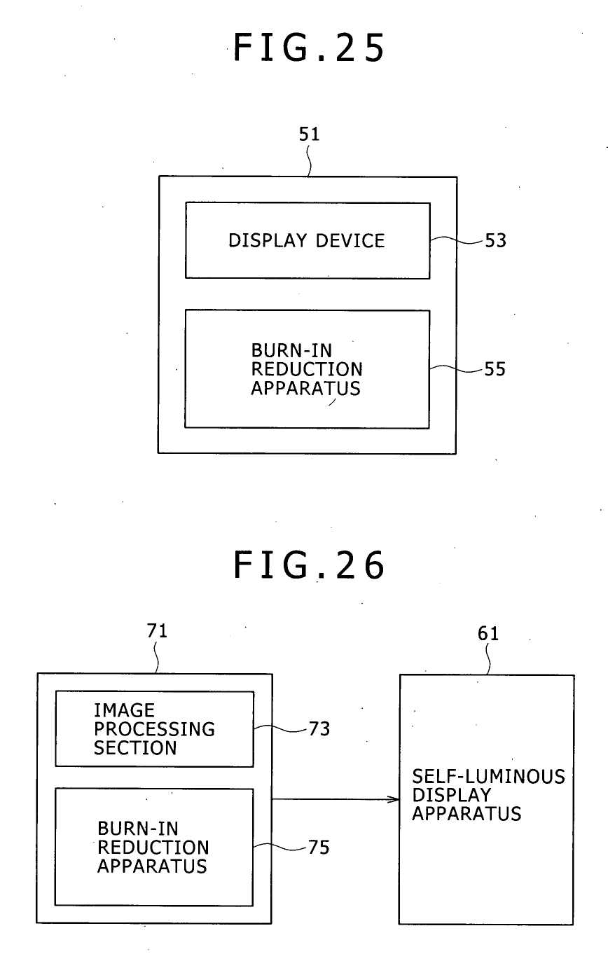

Referring to FIG. 25, the above-described burn-in reduction apparatus may be contained in a self-luminous display apparatus 51. The self-luminous display apparatus 51 as shown in FIG. 25 contains a display device 53 and a burn-in reduction apparatus 55.

(b) Image Processing Apparatus

Referring to FIG. 26, the above-described burn-in reduction apparatus may be contained in an image processing apparatus 71 that works as an external device that supplies a video signal to a self-luminous display apparatus 61.

The image processing apparatus 71 as shown in FIG. 26 includes an image processing section 73 and a burn-in reduction apparatus 75. A process performed by the image processing section 73 depends on an application installed.

Note that, however, the illumination sensor is contained in the self-luminous display apparatus 61 as its integral part, or is placed near the self-luminous display apparatus 61 and externally connected to the self-luminous display apparatus 61 or the burn-in reduction apparatus 75. In the case of this system configuration, the burn-in reduction apparatus 75 outputs video signals which have been gradation-converted in accordance with the brightness of the outside light to the self-luminous display apparatus 61, or outputs a signal for controlling the drive condition of the self-luminous display apparatus 61.

(c) Other Exemplary Implementations

The burn-in reduction apparatus can also be contained in various other electronic devices than the above-described apparatuses. Note that the electronic devices mentioned here may be either of a portable type or of a stationary type. Also note that the display device need not necessarily be contained in the electronic devices.

(c1) Broadcast Wave Reception Apparatus

The burn-in reduction apparatus may be contained in a broadcast wave reception apparatus.

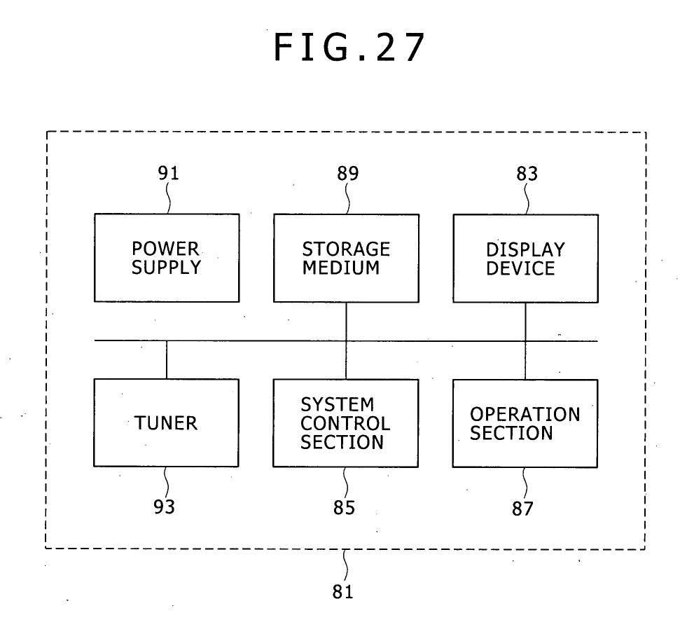

FIG. 27 illustrates an exemplary functional structure of a broadcast wave reception apparatus 81. The broadcast wave reception apparatus 81 contains, as its primary components, a display device 83, a system control section 85, an operation section 87, a storage medium 89, a power supply 91, and a tuner 93.

The system control section 85 is formed by a microprocessor, for example. The system control section 85 controls an overall system operation. The operation section 87 may be a mechanical operation unit or a graphic user interface.

The storage medium 89 is used as storage space for data corresponding to an image or video displayed on the display device 83, firmware, an application program, etc. In the case where the broadcast wave reception apparatus 81 is of a portable type, a battery power supply is used as the power supply 91. Needless to say, in the case where the broadcast wave reception apparatus 81 is of a stationary type, a commercial power supply may be used.

The tuner 93 is a device for selectively receiving a broadcast wave of a specific channel selected by a user among incoming broadcast waves.

The structure of this broadcast wave reception apparatus can be applied to a television program receiver, a radio program receiver, or a portable electronic device having a broadcast wave reception capability, for example.

(c2) Audio System

The burn-in reduction apparatus may be contained in an audio system.

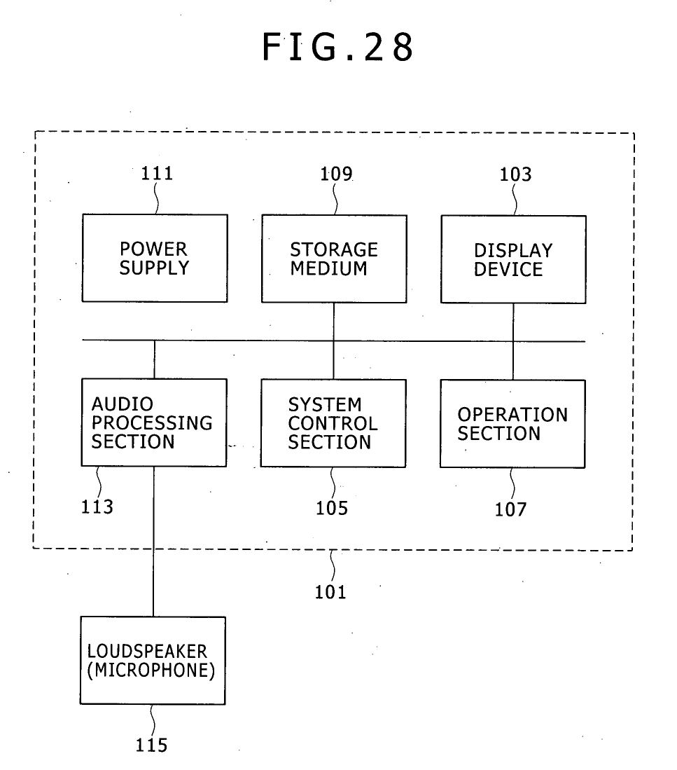

FIG. 28 illustrates an exemplary functional structure of an audio apparatus 101 as a playback device.

The audio apparatus 101 as the playback device contains, as its primary components, a display device 103, a system control section 105, an operation section 107, a storage medium 109, a power supply 111, an audio processing section 113, and a loudspeaker 115.

In this case also, the system control section 105 is formed by a microprocessor, for example. The system control section 105 controls an overall system operation. The operation section 107 may be a mechanical operation unit or a graphic user interface. Operation information, tune information, and the like are displayed on the display device 103.

The storage medium 109 is storage space for audio data, firmware, an application program, etc. The storage medium 109 is also used to store tune data. The storage medium 109 is formed by a semiconductor storage medium, a hard disk device, or the like.

In the case where the audio apparatus 101 is of a portable type, a battery power supply is used as the power supply 111. Needless to say, in the case where the audio apparatus 101 is of a stationary type, the commercial power supply may be used.

The audio processing section 113 is a processing device for subjecting the audio data to signal processing. Decompression of compressed audio data is also executed therein. The loudspeaker 115 is a device for outputting reproduced sound.

In the case where the audio apparatus 101 is used as a recorder, a microphone is connected thereto in place of the loudspeaker 115. In this case, the audio processing section 113 may have a function of compressing the audio data.

The structure of this audio system can be applied to a portable music device, a mobile phone, or the like, for example.

(c3) Communication Apparatus

The burn-in reduction apparatus may be contained in a communication apparatus.

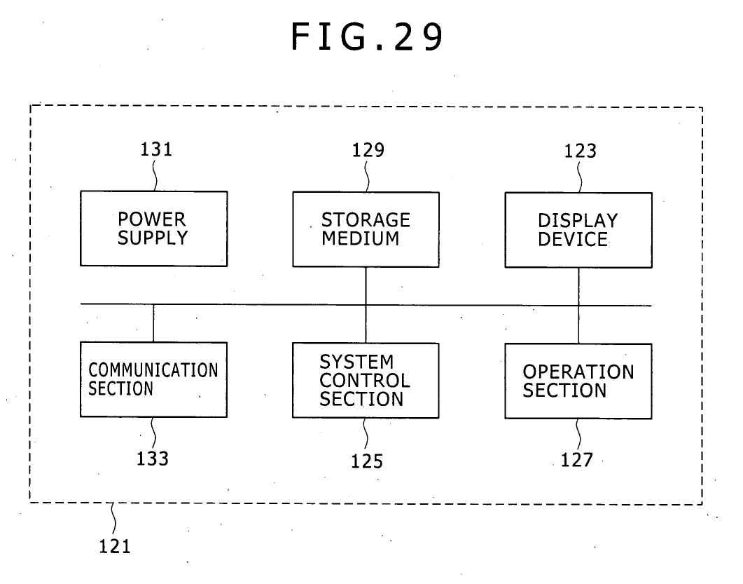

FIG. 29 illustrates an exemplary functional structure of a communication apparatus 121. The communication apparatus 121 contains, as its primary components, a display device 123, a system control section 125, an operation section 127, a storage medium 129, a power supply 131, and a communication section 133.

The system control section 125 is formed by a microprocessor, for example. The system control section 125 controls an overall system operation. The operation section 127 may be a mechanical operation unit or a graphic user interface.

The storage medium 129 is used as storage space for a data file corresponding to an image or video displayed on the display device 123, firmware, an application program, etc. In the case where the communication apparatus 121 is of a portable type, a battery power supply is used as the power supply 131. Needless to say, in the case where the communication apparatus 121 is of a stationary type, the commercial power supply may be used.

The communication section 133 is formed by a wireless or wired communication module for transmitting and receiving data to and from another device. The structure of this communication apparatus can be applied to a stationary telephone, a mobile phone, a portable electronic device having a communication capability, or the like, for example.

(c4) Imaging Apparatus

The burn-in reduction apparatus may be contained in an imaging apparatus.

FIG. 30 illustrates an exemplary functional structure of an imaging apparatus 141. The imaging apparatus 141 contains, as its primary components, a display device 143, a system control section 145, an operation section 147, a storage medium 149, a power supply 151, and an imaging section 153.

The system control section 145 is formed by a microprocessor, for example. The system control section 145 controls an overall system operation. The operation section 147 may be a mechanical operation unit or a graphic user interface.

The storage medium 149 is used as storage space for a data file corresponding to an image or video displayed on the display device 143, firmware, an application program, etc. In the case where the imaging apparatus 141 is of a portable type, a battery power supply is used as the power supply 151. Needless to say, in the case where the imaging apparatus 141 is of a stationary type, the commercial power supply may be used.

The imaging section 153 is, for example, formed by a CMOS sensor and a signal processing section for processing a signal outputted from the CMOS sensor. The structure of this imaging apparatus can be applied to a digital camera, a video camera, a portable electronic device having an imaging capability, or the like, for example.

(c5) Information Processing Apparatus

The burn-in reduction apparatus may be contained in a portable information processing apparatus.

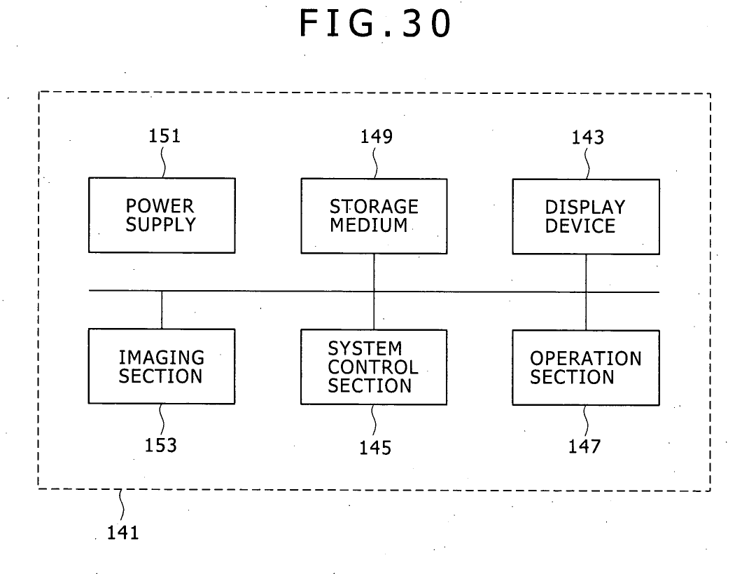

FIG. 31 illustrates an exemplary functional structure of a portable information processing apparatus 161. The information processing apparatus 161 contains, as its primary components, a display device 163, a system control section 165, an operation section 167, a storage medium 169, and a power supply 171.

The system control section 165 is formed by a microprocessor, for example. The system control section 165 controls an overall system operation. The operation section 167 may be a mechanical operation unit or a graphic user interface.

The storage medium 169 is used as storage space for a data file corresponding to an image or video displayed on the display device 163, firmware, an application program, etc. In the case where the information processing apparatus 161 is of a portable type, a battery power supply is used as the power supply 171. Needless to say, in the case where the information processing apparatus 161 is of a stationary type, the commercial power supply may be used.

The structure of this information processing apparatus can be applied to a game machine, an electronic book, an electronic dictionary, a computer, a measuring device, or the like, for example. Note that in the case of the measuring device, a detection signal of a sensor (a detection device) is inputted to the system control section 165.

### (D) Other Exemplary Embodiments

(a) In exemplary first embodiment described above, the reference voltage value D_{b} that defines the black level of the data line driver 23 and the reference voltage value D_{w} that defines the white level of the data line driver 23 are supplied from the contrast control section 5 to the display device 7.

However, the contrast control section 5 may supply only the variation in the black or white level or only the variations in the black and white levels to the display device 7, so that the reference voltage V_{b} and/or V_{w} corresponding to the variation(s) is generated in the display device 7.

(b) In exemplary first embodiment described above, in the case where the display brightness of the white level is to be decreased, the reference voltage value that defines the white level of the data line driver 23 is variably controlled.

However, the decrease in the display brightness of the white level can also be achieved by controlling an L level length of the duty pulse signal, the L level length defining an illumination period of the display device 7 within one frame.

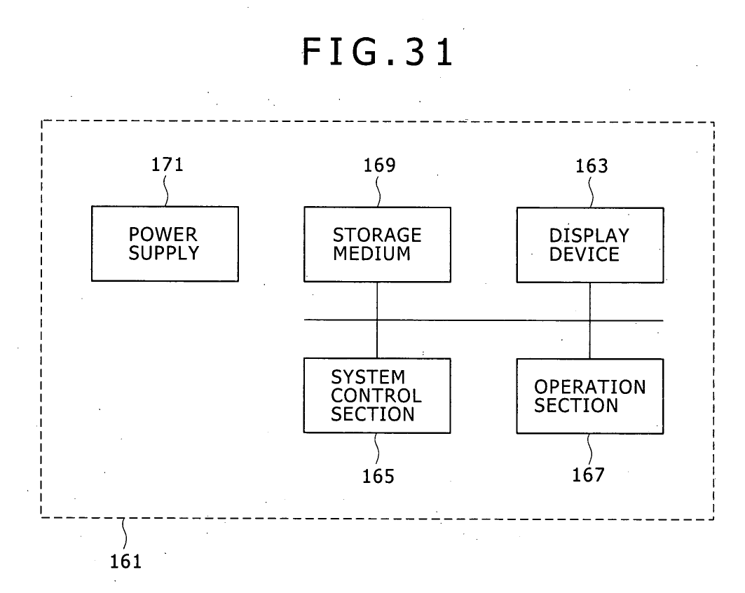

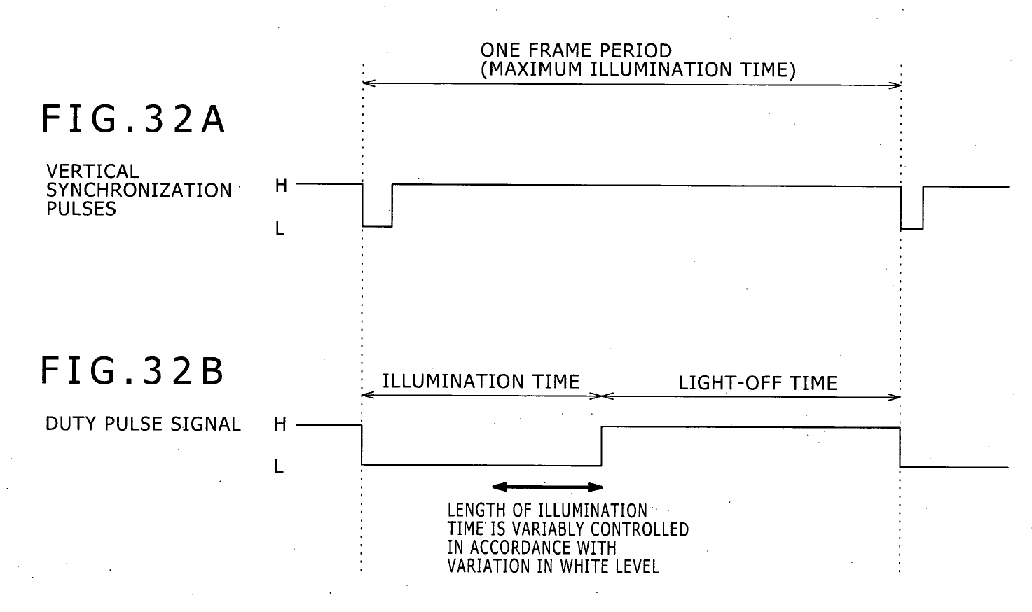

FIGS. 32A and 32B illustrate exemplary variable control of the duty pulse signal. FIG. 32A shows vertical synchronization pulses that define a maximum period of the length of a maximum illumination time. FIG. 32B shows an exemplary duty pulse signal. As shown in FIG. 32B, the L level length is variably controlled in accordance with the variation in the white level. The greater the variation (the amount of reduction) is, the shorter the L level length should be made by the control.

(c) In the exemplary embodiments described above, the white and black levels of the display brightness are changed to reduce the contrast ratio.

However, in addition to this reduction control, gradation conversion characteristics or a middle reference voltage of the data line driver 23 may be changed so that the shape of a gamma conversion curve that defines correspondence between the input signal and output brightness will approach a straight line.

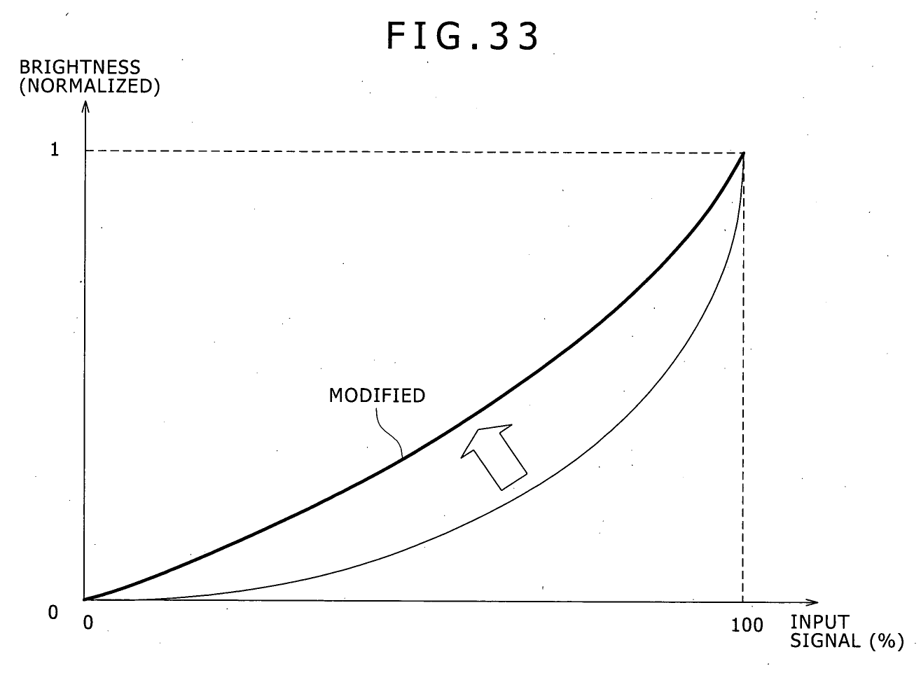

FIG. 33 illustrates an example of this type of control. In FIG. 33, a thick line represents an exemplary gamma conversion curve when the contrast ratio is reduced. As a result of a sharp-to-gentle change in the shape of the gamma conversion curve as indicated by an arrow, difference in brightness between parts having high gradation values and parts having low gradation values is further reduced. Thus, the contrast ratio is further reduced.

(d) In the exemplary embodiments described above, the contrast ratio of the display brightness is reduced steplessly, basically.

However, the contrast ratio may be reduced in a stepwise manner as when the conversion table is used.

(e) In the exemplary embodiments described above, the duty pulse signal is outputted once in one frame period (see FIG. 4).

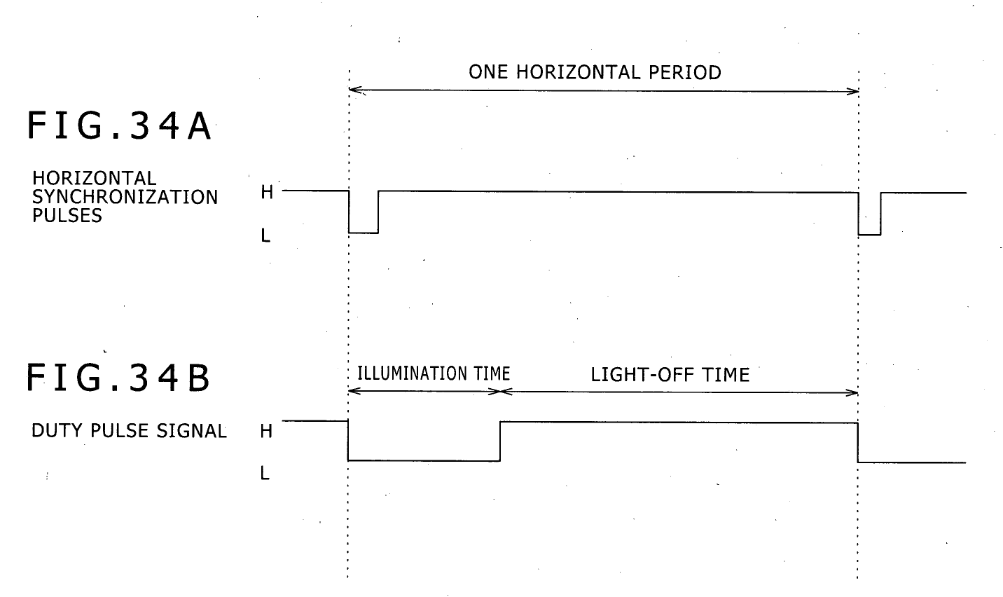

However, as illustrated in FIG. 34, the duty pulse signal may be outputted once in one horizontal period.

(f) In the exemplary embodiments described above, the display device is an organic EL display.

However, the display device may be another type of self-luminous display device.

For example, the display device may be an inorganic EL display device, an FED display device, or a PDP display device.

(g) In the burn-in reduction apparatuses described in the above-described exemplary embodiments, all processing functions may be implemented in hardware or software, or alternatively, it may be so arranged that some of the processing functions are implemented in hardware and the others in software.

(h) It should be understood by those skilled in the art that various modifications, combinations, sub-combinations and alterations may occur depending on design and other factors insofar as they are within the scope of the appended claims or the equivalents thereof.

What is claimed is:

1. A burn-in reduction apparatus, comprising:
an illumination sensor configured to detect brightness of outside light incident on an area near a display screen; and
a contrast control section configured to control a drive condition of a display device in accordance with the detected brightness to reduce a contrast ratio of display brightness steplessly or in a stepwise manner.

2. The burn-in reduction apparatus according to claim 1, wherein, when the outside light incident on the area near the display screen is bright, said contrast control section reduces the contrast ratio of the display brightness by raising a black level of a displayed image.

3. The burn-in reduction apparatus according to claim 1, wherein, when the outside light incident on the area near the display screen is bright, said contrast control section reduces the contrast ratio of the display brightness by reducing a white level of a displayed image.

4. The burn-in reduction apparatus according to claim 1, wherein, when the outside light incident on the area near the display screen is bright, said contrast control section reduces the contrast ratio of the display brightness by raising a black level of a displayed image and reducing a white level of the displayed image.

5. The burn-in reduction apparatus according to claim 1, wherein, when the outside light incident on the area near the display screen is dark, said contrast control section reduces the contrast ratio of the display brightness by raising a black level of a displayed image.

6. The burn-in reduction apparatus according to claim 1, wherein, when the outside light incident on the area near the display screen is dark, said contrast control section reduces the contrast ratio of the display brightness by raising a black level of a displayed image and reducing a white level of the displayed image.

7. The burn-in reduction apparatus according to claim 1, wherein said contrast control section reduces the contrast ratio of the display brightness by controlling at least one of reference voltage values that define white and black levels of a displayed image.

8. The burn-in reduction apparatus according to claim 1, wherein said contrast control section reduces the contrast ratio of the display brightness by controlling a duty pulse signal length that defines a proportion of an illumination time within one frame period.

9. A burn-in reduction apparatus, comprising:
an illumination sensor configured to detect brightness of outside light incident on an area near a display screen; and
a contrast control section configured to perform gradation conversion of video signals in accordance with the detected brightness to reduce a contrast ratio of display brightness steplessly or in a stepwise manner.

10. A self-luminous display apparatus, comprising:
a self-luminous matrix display device;
an illumination sensor configured to detect brightness of outside light incident on an area near a display screen of said display device; and
a contrast control section configured to control a drive condition of said display device in accordance with the detected brightness to reduce a contrast ratio of display brightness steplessly or in a stepwise manner.

11. A self-luminous display apparatus, comprising:
a self-luminous matrix display device;
an illumination sensor configured to detect brightness of outside light incident on an area near a display screen of said display device; and
a contrast control section configured to perform gradation conversion of video signals in accordance with the detected brightness to reduce a contrast ratio of display brightness steplessly or in a stepwise manner.

12. An image processing apparatus, comprising:
an illumination sensor configured to detect brightness of outside light incident on an area near a display screen;
a contrast control section configured to control a drive condition of a display device in accordance with the detected brightness to reduce a contrast ratio of display brightness steplessly or in a stepwise manner; and
a signal processing section configured to process a video signal.

13. An image processing apparatus, comprising:
an illumination sensor configured to detect brightness of outside light incident on an area near a display screen;
a contrast control section configured to perform gradation conversion of video signals in accordance with the detected brightness to reduce a contrast ratio of display brightness steplessly or in a stepwise manner; and
a signal processing section configured to process the video signals.

14. An electronic device, comprising:
a self-luminous matrix display device;
an illumination sensor configured to detect brightness of outside light incident on an area near a display screen of said display device; and
a contrast control section configured to control a drive condition of said display device in accordance with the detected brightness to reduce a contrast ratio of display brightness steplessly or in a stepwise manner.

15. An electronic device, comprising:
a self-luminous matrix display device;
an illumination sensor configured to detect brightness of outside light incident on an area near a display screen of said display device; and
a contrast control section configured to perform gradation conversion of video signals in accordance with the detected brightness to reduce a contrast ratio of display brightness steplessly or in a stepwise manner.

16. A method for reducing burn-in, the method comprising the steps of:
detecting brightness of outside light incident on an area near a display screen; and
controlling a drive condition of a display device in accordance with the detected brightness to reduce a contrast ratio of display brightness steplessly or in a stepwise manner.

17. A method for reducing burn-in, the method comprising the steps of:
detecting brightness of outside light incident on an area near a display screen; and
performing gradation conversion of video signals in accordance with the detected brightness to reduce a contrast ratio of display brightness steplessly or in a stepwise manner.

18. A computer program for causing a computer to execute the steps of:
detecting brightness of outside light incident on an area near a display screen; and
controlling a drive condition of a display device in accordance with the detected brightness to reduce a contrast ratio of display brightness steplessly or in a stepwise manner.

19. A computer program for causing a computer to execute the steps of:
detecting brightness of outside light incident on an area near a display screen; and
performing gradation conversion of video signals in accordance with the detected brightness to reduce a contrast ratio of display brightness steplessly or in a stepwise manner.
